(19) United States
(12) Patent Application Publication
(10) Pub. No.: US 2026/0341568 A1
(43) Pub. Date: Oct. 29, 2026

(54) MAGNETIC COMPONENT, IN PARTICULAR QUANTUM COMPONENT

(71) Applicants: C12 Quantum Electronics, Paris (FR); Centre National de la Recherche Scientifique, Paris (FR); Université de Lorraine, Paris (FR)

(72) Inventors: Sandrine Lopes, Paris (FR); William Legrand, Paris (FR); Matthieu Desjardins, Paris (FR); François Montaigne, Nancy Cedex (FR); Daniel Lacour, Paris (FR); Michel Hehn, Nancy Cedex (FR)

(21) Appl. No.: 19/109,940

(22) PCT Filed: Sep. 8, 2023
(86) PCT No.: PCT/EP2023/074739

§ 371 Date: Mar. 7, 2025

(30) Foreign Application Priority Data
Sep. 8, 2022 (FR) FR2209018

(51) Int. Cl. H01F 10/32; G06N 10/40; H01F 41/32

(52) U.S. Cl. CPC H01F 10/3268; G06N 10/40; H01F 41/32

(57) ABSTRACT

A magnetic component comprises a substrate supporting at least one pair of permanent magnets extending in a first direction, each magnet having an interaction end, the interaction ends being arranged facing one another, the pair of magnets being arranged so as to exert an antisymmetric magnetic field with a high magnetic field gradient along a second direction orthogonal to the first direction, under the effect of a magnetic field produced by external magnetic means.

### CROSS-REFERENCE TO RELATED APPLICATIONS

This application is a national phase entry under 35 U.S.C. § 371 of International Patent Application PCT/EP2023/074739, filed Sep. 8, 2023, designating the United States of America and published as International Patent Publication WO 2024/052533 A1 on Mar. 14, 2024, which claims the benefit under Article 8 of the Patent Cooperation Treaty of French Patent Application Serial No. FR2209018, filed Sep. 8, 2022.

### TECHNICAL FIELD

The present disclosure relates to a magnetic component in the field of micro- and nano-electronics, in particular, a quantum component. The quantum component is intended in particular, but not exclusively, to manufacture a quantum computer. It may also be of interest in the fields of spintronics, topological superconductivity, magnetic actuation of nano-elements and nano-beads, or near-field magnetic detection using scanning probes.

### BACKGROUND

There are devices designed to generate a magnetic field, in particular, directions via magnets, referred to by those skilled in the art as micro-magnets in the field of micro- and nano-electronics.

One aim of the present disclosure is to propose a new quantum component architecture making it possible to significantly reduce the quantum misalignment observed in the quantum components of the prior art, and thus to improve the performance of these components.

### BRIEF SUMMARY

To this end, and according to a first aspect, the present disclosure proposes a magnetic component comprising a substrate supporting at least one pair of permanent magnets extending in a first direction, each magnet having an interaction end, the interaction ends being arranged facing one another, the pair of magnets being arranged so as to exert an antisymmetric magnetic field with respect to the X=0 plane, with a high magnetic field gradient along a second direction orthogonal to the first direction, and a symmetrical magnetic field with respect to the X=0 plane along the first direction (X) orthogonal to the Y and Z directions, under the effect of a magnetic field produced by external magnetic means.

For the foregoing and for the rest of the description, the terms below have the definitions as follows:
quantum component, an assembly of electronic circuits and/or devices using nanotubes as conductive or semi-conductive elements thereof, the circuits having single, double or multiple quantum dots, in series or in parallel, using a single nano-object having selected properties as channel elements, or a plurality of separately selected nano-objects;
a quantum dot, a portion of the nano-object in which an electron is trapped/confined in three dimensions; it can occupy only discrete energy levels;
a nano-object, an object having at least one of its external dimensions (typically from its height, width, thickness, length) be less than 100 nanometers; if its three external dimensions (defined along three orthogonal axes) are less than 100 nanometers, then it is a nanoparticle; if two of its external dimensions (preferably defined along two orthogonal axes) are less than 100 nanometers, then that is, for example, a hollow single-wall or multi-wall nanotube, which can be closed at least one end or a nanofiber, that is a solid fiber. An electrically conductive or semi-conductive nanofiber will subsequently be called a nanowire. If an external dimension is less than 100 nm (typically its thickness) then it is a nanosheet;
an electrode, an end of an electrical conductor arranged to release or capture an electric current;
a gate electrode, an electrode that transports a microwave signal or that makes it possible to set the potentials (in Volts);
a microwave gate electrode, a gate electrode that transports and radiates a microwave signal that allows interaction between a microwave cavity and a nano-object;
a low-frequency gate electrode, a gate electrode that allows electrostatic potentials to be set and to create a double quantum dot;
a magnet, a magnetic element that magnetizes under the effect of an external magnetic field;
electrostatic potentials enabling the formation of the two quantum dots, the electrostatic potentials, which make it possible to modulate the potential energy barriers and to create a double quantum dot;
Spin-photon coupling, the controllable interaction or “coupling” between the magnetic appearance of the qubit, which is its spin, and a microwave electric field coming from a microwave cavity. As the electric field consists of photons, we refer to spin-photon coupling;
Quantum gate, a logical operation that can change the state of superposition of a qubit. For example, a qubit can have a one-in-two chance of being in one or the other of the two states;
an inhomogeneous magnetic field, a magnetic field generated so as to generate a magnetic dipole, preferably by any variation of the magnetic field around and/or along the at least one nano-object element; for example, a vertical and/or horizontal component of the magnetic field changes its sign along or around the at least one nano-object element, preferably at or plumb with the at least one magnetic gate electrode; according to a particular example, a magnetic field gradient that is horizontal or along the at least one nano-object element, which renders the total field inhomogeneous along the at least one nano-object element, preferably the component of the magnetic field along the axis or direction of the at least one nano-object changes its sign along the at least one nano-object element;
spatial extent, the zone located along and/or around, preferably radially, the at least one nano-object element, preferably between the suspension electrodes, according to one embodiment, an extent corresponding to the distance between two quantum dots;
substrate, an element of the component having a high resistivity, for example, a higher dielectric constant than air, in particular, at low temperature.

According to a second aspect of the present disclosure, a quantum component is proposed comprising:
least two suspension electrodes: a source electrode connected to an electron source and a drain electrode connected to a reference potential, designed to receive a quantum element integrating a double quantum dot,
at least three gate electrodes arranged between the two suspension electrodes, the two suspension electrodes being raised relative to the at least three gate electrodes,
a magnetic component according to the present disclosure, designed to exert an antisymmetric magnetic field with a high magnetic field gradient along a second direction orthogonal to the first direction, under the effect of a magnetic field produced by external magnetic means, this antisymmetric magnetic field being applied to the quantum element.

According to a third aspect of the present disclosure, a method of manufacturing a quantum component according to the present disclosure is proposed, comprising the following steps:
etching a substrate to receive magnetic elements,
depositing at least one pair of magnets extending in a first direction (X), each magnet having an interaction end, the interaction ends being arranged facing one another,
performing low-angle etching of the substrate whereupon at least one pair of magnets has been deposited,
depositing an oxide layer on the treated substrate,
depositing suspension and gate electrodes on the oxide layer.

Preferably, according to any preceding aspect, the component or method may comprise one or more of the following features:
the pair of magnets itself generates an antisymmetric magnetic field (z-axis component) between the two dots (relative to the x=0 plane), and the applied external magnetic field generates a symmetrical field between the two dots;
between quantum dots separated by a distance of between 60 and 120 nanometers, these gradients result in an asymmetric field component that can reach around 30 mT or 40 mT (milli-Tesla);
If dots placed symmetrically with respect to the field distribution are considered, the fields in the two dots of the double quantum dot will be composed of a symmetric and an antisymmetric part.

It is possible to define, for each field component: i=u, v, w:

$${B}_{i}^{s , as} = ( {B}_{i}^{R} \pm {B}_{i}^{L} ) / 2$$

where L;R refer to the left (L) and right (R) quantum dots, respectively. This definition of the symmetric/asymmetric magnetic field for each vector component i (where u,v,w refer equivalently to the directions in space x,y,z). This definition makes sense in the context of a double quantum dot.

The effects of the stray fields on the energies in the left and right parts of the double quantum dot can then be expressed as:

$${α}_{s , as} = 2 {μ}_{B} \int \sqrt{{\sum }_{i} {( {B}_{i}^{s , as} ( r ) )}^{2}} {\vert {ψ}_{p} ( r ) \vert}^{2} dr$$

$$where$$

$${\vert {ψ}_{p} ( r ) \vert}^{2}$$

is the probability density of the electron's presence in the dot p (left or right), prefactor 2 represents the Landé factor of the electron spin and μB is the Bohr magneton.

This corresponds to the mathematical definition of the magnetic coupling constant between the electron in the quantum dots and the symmetric, respectively antisymmetric magnetic field. It will later be seen which is considered the quantity to be optimized (maximized).

The gradient must therefore be considered as an inhomogeneity between the two quantum dots of the fields averaged over each dot.

A pair of dots with linear confinement is now considered, as found in a double quantum dot in a nanowire. The dots are aligned along x and defined between −250 nm and −150 nm for the dot L, and between 150 nm and 250 nm for the dot R.

The nanowire is suspended at z=200 nm, above a magnetic layer extending over −100 nm<z<100 nm.

As the external magnetic field is preferably applied along the nanowire, whereas a transverse gradient is required, uniform magnetization along +x is assumed.

Since dots located above the magnetic system are now being considered, the following is used:

Q=∫B_{y/z}(x)|ψ_{L}(x)|²dx−∫B_{y/z}(x)|ψ_{R}(x)|²dx
where L and R are swapped in relation to the above. The definition of Q is a quantity that is optimized (see previous coupling constant between magnetic field and dots).

To guarantee practical shapes, a constraint is added so that the magnet is homogeneous along z.

Thus, this optimization consists in deciding on the presence or absence of a magnet in each or one or more cell(s) or one or more elements of the total thickness along the Z axis at all X and Y positions. This method of optimizing the quantity Q becomes linear with respect to the individual magnetic elements/cells;

The higher magnetic saturation MS directly favors higher parasitic fields and gradients; it also facilitates the formation of magnetic domains in the nanomagnets and therefore requires a higher external field to reach saturation.

This external field is added as a term

αₑₓₜ=2μ_{B}Bₑₓₜ
at αₛ from the symmetrical part of the parasitic fields in the formation of dot energy levels. By defining the inhomogeneity of the fields acting on the dots as

αₐₛ/(αₛ+αₑₓₜ),
this figure of merit decreases when a strong external field is used.

To optimize inhomogeneity, it is therefore necessary to identify the pairs of MS and Bext values that provide the highest value of

αₐₛ/(αₛ+αₑₓₜ)

This last point corresponds to the definition of the external magnetic field's contribution to the symmetrical component.

### BRIEF DESCRIPTION OF THE DRAWINGS

Other features and advantages of the present disclosure will emerge from the following detailed description of the present disclosure with reference to the appended figures, and in which:

FIG. 1 is a schematic depiction of a quantum component comprising electrodes extending substantially perpendicular to the two series of magnets according to one embodiment;

FIG. 2 shows two series of magnets running parallel to one another within the same series and between the two series, with the magnet ends of the first series facing the magnet ends of the second series, and both series of magnets lying in the same plane;

FIG. 3 is a schematic depiction of two magnet ends facing one another and a nanotube connecting the two ends according to one embodiment of a quantum component, this depiction being arranged in a three-dimensional frame of reference;

FIG. 4 is a nanoscale depiction of the saturation of the magnetic field at the ends of the two magnets;

FIG. 5 shows curves of magnetic field components along a carbon nanotube, in particular, the magnetic field distribution along a carbon nanotube obtained with the micro-magnets according to FIG. 2;

FIGS. 6A-6D show the impact of the external magnetic field on the various physical quantities, with three different magnet materials.

For greater clarity, identical or similar elements of the various embodiments are denoted by identical reference signs in all of the figures.

### DETAILED DESCRIPTION

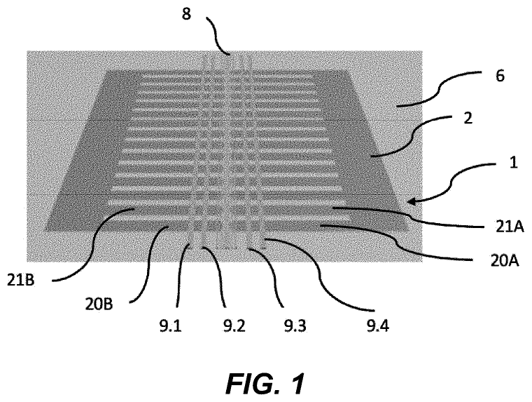

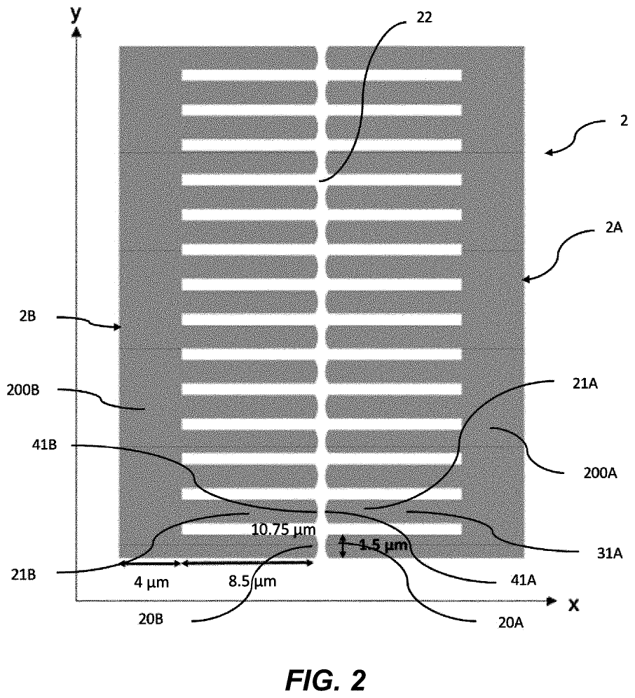

In relation to FIGS. 1 and 2, an embodiment of a quantum component 1 is shown comprising:
a substrate 6, made of a high resistivity material, for example,
a magnetic device 2, acting as a magnetic electrode, arranged to generate a magnetic field to which the quantum component 1 is subjected, comprising two comb-shaped parts 2A, 2B arranged facing one another and separated by a central gap 22 in which a dedicated magnetic field is generated,
a set of gate electrodes 8 placed above the central gap 22, these gate electrodes being surrounded by a source electrode 9.1, a cut-source electrode 9.2, a cut-drain electrode 9.3, and a drain electrode 9.4,
a nanotube or nanowire (not visible in FIG. 1) connected to the suspension electrodes, the nanotube or nanowire being suspended rectilinearly above the gate electrodes and above a set of substantially parallel magnets, preferably made of carbon.

The source and drain electrodes are placed on a conductive layer via an insulating layer. They act as suspension electrodes for the nanotube or nanowire, and are raised above the gate electrodes. This arrangement is specific to a quantum component including a carbon nanotube.

Referring to FIG. 2, the magnetic device 2 comprises permanent magnets arranged in the form of two opposing combs 2A, 2B, a first comb and a second comb. Each comb 2A, 2B comprises a plurality of generally rectangular magnets 20A, 20B; 21A, 21B arranged parallel to one another. The series of magnets in each comb is connected along the Z axis to the two opposite ends of the counterpart.

According to the embodiment shown, each comb 2A, 2B comprises 15 magnets. Each magnet is 1.5 micrometers wide and 8.5 micrometers long. The width is chosen so as to make the magnetic moments parallel to the boundaries due to the internal dipole energies. Preferably, each magnet is spaced laterally, along the Y axis, by a distance of 0.75 micrometers. Preferably, each comb 2A, 2B has a thickness of 400 nanometers. Preferentially, each magnet comprises iron and cobalt, preferably with high remanence.

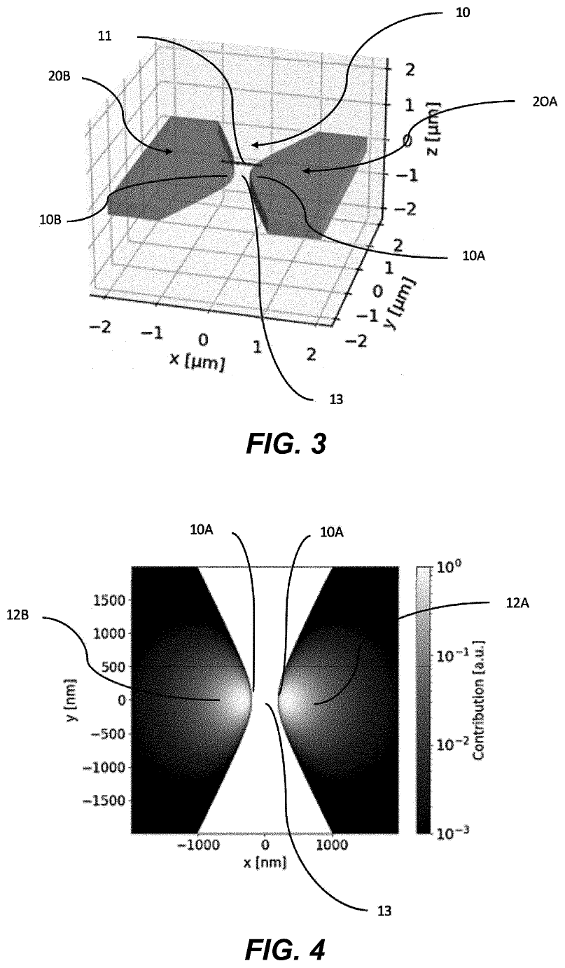

Each magnet 21A of a first comb 2A has, with reference to FIGS. 2 and 3, an interaction end or magnetic pole 41A, arranged to face an interaction end or pole 41B of a magnet 21B of the second comb 2B. Each transverse face is opposite a transverse face of a magnet on the second comb. Preferably, the distance between two interaction ends or magnet poles is between 0.4 and 1 micrometer. The spacing is measured between the distal points of the interaction ends.

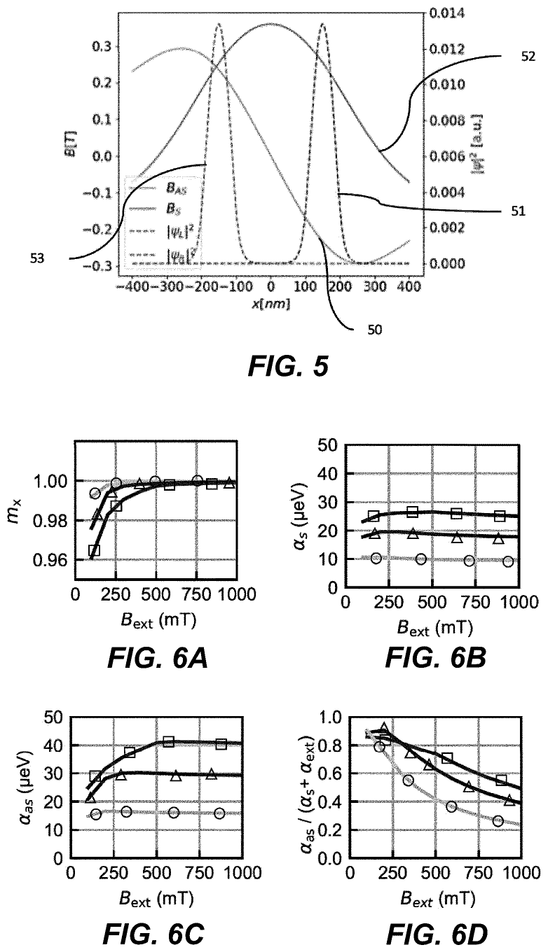

Preferably, each interaction end has a rounded shape when viewed along a two-dimensional plane, or longitudinal plane, shown by the X-Y plane in FIG. 2. Additionally, FIGS. 3, 4 and 5 show the optimal shapes of a saturated nanomagnet in the case of quantum dots of finite extension, in particular, the uniform magnetization imposed along x, maximizing a field difference Bz. Preferably, the rounded distal part, in particular, the three-dimensional ovoid, contributes most to magnetic field optimization. The shape of the interaction end aligns the magnetic moments in a single direction.

Additionally, each magnet 21A has a connection end 31A, opposite the interaction end 41A. Each comb 2A,2B further comprises a magnet connecting piece 200A,200B, so that each magnet of a comb 2A,2B is connected to the connecting piece 200A,200B of the comb 2A,2B via the connection end. According to the embodiment shown, the connecting piece 200A, 200B is 4 micrometers wide.

This embodiment offers an anisotropic shape and produces a homogeneous magnetic field in the Y direction for the nanotube. The reduced dimensions of the magnets result in shape anisotropy, with magnetic moments tending to be parallel to the boundaries due to internal dipole energies.

Preferably, the two magnet combs 2A, 2B are inlaid in the substrate 6.

Additionally, the quantum component comprises external magnetic means (not shown) arranged to exert a magnetic field along the X direction. For example, a toroid (not shown) surrounds the electrodes and combs. Preferably, this toroid generates a magnetic field of between 200 and 500 milli-Tesla.

The quantum component thus proposes to exert an antisymmetric magnetic field with a strong magnetic field gradient along the Z direction orthogonal to the X direction, under the effect of a magnetic field generated by external magnetic means. For example, according to tests carried out, the antisymmetric field constant reaches 26.8 micro-eV and the symmetric field constant reaches 29 micro-eV, making it possible to optimize spin-photon coupling.

The quantum component optimizes the distribution of magnetic moments around the quantum dots, the magnetic field gradient, and thus the interaction between magnet and nano-object or nanotube, comprising at least two quantum dots. Preferably, the nano-object or nanotube is about 100 nanometers above the magnet pair under consideration.

FIGS. 6A-6D show the results of micromagnetic simulations of a shape optimized for an inhomogeneous component Bz, with an external field Bext and magnetization along x. Based on the external magnetic field, (a) magnetization mx, (b) symmetric (alpha s), (c) antisymmetric (alpha as) coupling constants due to the nanomagnets, and (d) the ratio between the antisymmetric field and the total symmetric field

αₐₛ/(αₛ+αₑₓₜ)

The different colors correspond to CoFe (line with squares), Co (line with triangles) and NiFe (line with circles).

1. A magnetic component, comprising: a substrate receiving at least one pair of permanent magnets extending in a first X direction, each magnet having an interaction end, the interaction ends being arranged facing one another, the at least one pair of magnets being arranged so as to exert an antisymmetric magnetic field with respect to an X=0 plane, with a high magnetic field gradient along a second Z direction orthogonal to the first X direction, and a symmetrical magnetic field with respect to the X=0 plane along the first X direction orthogonal to a third Y direction and the second Z direction, under an effect of a magnetic field produced by external magnetic means.

2. The magnetic component of claim 1, further comprising several pairs of magnets facing one another so as to form two combs.

3. The magnetic component of claim 1, wherein each magnet has a rectilinear shape.

4. The magnetic component of claim 1, wherein each magnet interaction end has a rounded shape.

5. The magnetic component of claim 4, wherein the rounded shape is curvilinear with a predefined radius of curvature.

6. The magnetic component of claim 4, wherein each magnet end is three-dimensionally rounded.

7. The magnetic component of claim 1, wherein each magnet interaction end has a shape without protrusions.

8. The magnetic component of claim 1, wherein at least one magnet is inlaid in the substrate.

9. The magnetic component of claim 1, wherein at least one magnet is deposited on the substrate.

10. A quantum component, comprising:
a source electrode connected to an electron source and a drain electrode connected to a reference potential, designed to receive a quantum element integrating a double quantum dot;
at least three gate electrodes arranged between the source and drain electrodes;
a magnetic component according to claim 1, configured to exert an antisymmetric magnetic field with a high magnetic field gradient along the second Z direction orthogonal to the first X direction, under the effect of a magnetic field produced by external magnetic means, this antisymmetric magnetic field being applied to the quantum element.

11. The quantum component of claim 10, wherein the source and drain electrodes constitute suspension electrodes that are raised relative to the at least three gate electrodes.

12. The quantum component of claim 11, further comprising at least, as a quantum element, a nano-object element suspended between the suspension electrodes, and electrically connected thereto, the nano-object element being disposed above the at least three gate electrodes.

13. The quantum component of claim 10, further comprising, as a quantum element, an electron gas located in a substrate arranged between the source and drain electrodes.

14. The quantum component of claim 10, wherein the quantum element is arranged at a distance of about 100 nm above the at least one magnet pair.

15. The quantum component of claim 10, wherein the magnets of a pair are arranged symmetrically with respect to a plane orthogonal to a direction of the at least one quantum element.

16. A method for manufacturing a quantum component according to claim 10, comprising:
etching a substrate to receive magnetic elements;
depositing at least one pair of magnets extending in a first X direction, each magnet having an interaction end, the interaction ends being arranged facing one another;
performing low-angle etching of the substrate whereupon at least one pair of magnets has been deposited;
depositing an oxide layer on the treated substrate; and
depositing suspension and gate electrodes on the oxide layer.
